(19) United States
(12) Patent Application Publication
(10) Pub. No.: US 2025/0373905 A1
(43) Pub. Date: Dec. 4, 2025

(54) SYSTEM, METHOD, AND DEVICES FOR PROVIDING TEXT INTERPRETATION TO MULTIPLE CO-WATCHING DEVICES

(71) Applicant: Google LLC, Mountain View, CA (US)

(72) Inventors: Ruofei Du, San Francisco, CA (US); Yinda Zhang, Palo Alto, CA (US)

(21) Appl. No.: 19/105,267

(22) PCT Filed: Aug. 22, 2022
(86) PCT No.: PCT/US2022/075272

§ 371 Date: Feb. 20, 2025

(51) Int. Cl. H04N 21/488; H04N 21/41; H04N 21/4788

(52) U.S. Cl. CPC H04N 21/4884; H04N 21/4126; H04N 21/4788

(57) ABSTRACT

Methods, a system, and a device are provided to allow co-watch devices to coordinate text interpretation services while co-watching a video or live event. A server receives an indication that a first co-watch device and a second co-watch device are preparing to co-watch a video or a live event while displaying a text interpretation of a speech component of the video or live event. An indication is sent to a first device of the first and second co-watch devices to operate as a text-processing device, generating the text interpretation, and transmitting the text interpretation to a second device of the first and second co-watch devices. The first device receives a portion of a video, processes a speech component of the portion of the video to generate a text interpretation, and sends the text interpretation to a second device.

### TECHNICAL FIELD

This description generally relates to methods, devices, and systems to provide a display of a text interpretation.

### BACKGROUND

Text interpretation services for videos and events allow for users to better understand and access human speech. Providing text interpretation for videos and events may be costly with respect to processing and power consumption, however.

### SUMMARY

The present application relates to the problem of providing text interpretation during a video or live event being co-watched by multiple users using respective co-watch devices while minimizing the processing and/or battery usage among the devices. In at least one example, multiple users co-watch videos together. In at least one example, one user is watching and creating a video of a live event that is streamed to the other users concurrently for viewing on their own respective co-watch devices. In some examples, one of the co-watching user devices generates a text interpretation of a speech component of the event and sends the text interpretation to the other co-watch devices. The methods, systems, and devices disclosed herein describe configuring the co-watching devices to either operate as a text interpretation device or to receive a text interpretation from the text interpretation device.

In some aspects, the techniques described herein relate to a computer-implemented method including: receiving an indication that a first co-watch device and a second co-watch device are preparing to co-watch a video while displaying a text interpretation of a speech component of the video; and sending an indication to a first device of the first co-watch device and the second co-watch device to operate as a text-processing device to generate the text interpretation and transmit the text interpretation to a second device of the first co-watch device and the second co-watch device while co-watching the video. The method may further include any combination of the following features, in any possible combination.

In some aspects, the techniques described herein relate to a computer-implemented method, wherein co-watching the video includes the first co-watch device and the second co-watch device being coordinated to concurrently display a portion of the video.

In some aspects, the techniques described herein relate to a computer-implemented method, further including: sending an indication to the second device to prepare to receive the text interpretation from the first device.

In some aspects, the techniques described herein relate to a computer-implemented method, wherein the text interpretation is at least one of a translation, a transcription, and a summarization of the speech component.

In some aspects, the techniques described herein relate to a computer-implemented method, wherein at least one of the first co-watch device and the second co-watch device is in communication with a head mounted device operable to display the text interpretation on a head mounted device display.

In some aspects, the techniques described herein relate to a computer-implemented method, further including: determining that the first device is a co-watch host device operable to initiate co-watching the video with the second device.

In some aspects, the techniques described herein relate to a computer-implemented method, further including: determining that the first device has a first battery charge level that is greater than a second battery charge level of the second device.

In some aspects, the techniques described herein relate to a computer-implemented method, further including: upon receiving an indication that a re-evaluation event has occurred, the re-evaluation event including at least one of: determining that a timeout period has elapsed, determining that the first co-watch device or the second co-watch device are no longer displaying the video, determining that a battery powering the first co-watch device or the second co-watch device has a charge level below a threshold, and determining that the text-processing device has generated a text interpretation for a portion of the video including at least a predetermined word count: sending an indication to the second device to operate as the text-processing device; and sending an indication to the first device to prepare to receive the text interpretation from the second device.

In some aspects, the techniques described herein relate to a computer-implemented method including: receiving an indication that a first co-watch device and a second co-watch device are preparing to co-watch an event while displaying a text interpretation of a speech component of the event, the first co-watch device generating a video of the event with a camera and transmitting the video to the second co-watch device for concurrent display during the event; and sending an indication to a first device of the first co-watch device and the second co-watch device to operate as a text-processing device to generate the text interpretation and transmit the text interpretation to a second device of the first co-watch device and the second co-watch device while co-watching the event.

In some aspects, the techniques described herein relate to a computer-implemented method, further including: sending an indication to the second device to prepare to receive the text interpretation from the first device.

In some aspects, the techniques described herein relate to a computer-implemented method, wherein the text interpretation is at least one of a translation, transcription, and a summarization of the speech component.

In some aspects, the techniques described herein relate to a computer-implemented method, wherein at least one of the first co-watch device and the second co-watch device is connected to an augmented reality viewing device or a virtual reality viewing device.

In some aspects, the techniques described herein relate to a system, including: a first co-watch device; a second co-watch device; and a configuration server configured to receive an indication that the first co-watch device and the second co-watch device are preparing to co-watch a video while displaying a text interpretation of a speech component of the video, and send an indication to a first device of the first co-watch device and the second co-watch device to operate as a text-processing device to generate the text interpretation and transmit the text interpretation to a second device of the first co-watch device and the second co-watch device while co-watching the video.

In some aspects, the techniques described herein relate to a system, wherein co-watching the video includes the first co-watch device and the second co-watch device being coordinated to concurrently display a portion of the video.

In some aspects, the techniques described herein relate to a system, wherein the configuration server is further configured to send an indication to the second device to prepare to receive the text interpretation from the first device.

In some aspects, the techniques described herein relate to a system, wherein the text interpretation is at least one of a translation and a summarization of the speech component.

In some aspects, the techniques described herein relate to a system, wherein at least one of the first co-watch device and the second co-watch device is in communication with a head mounted device operable to display the text interpretation on a head mounted device display.

In some aspects, the techniques described herein relate to a system, wherein the configuration server is further configured to determine that the first device is a co-watch host device operable to initiate co-watching the video with the second device.

In some aspects, the techniques described herein relate to a system, wherein the configuration server is further configured to determine that the first device has a first battery charge level that is greater than a second battery charge level of the second device.

In some aspects, the techniques described herein relate to a system, wherein the configuration server is further configured to receive an indication that a re-evaluation event has occurred, the re-evaluation event including at least one of: determining that a timeout period has elapsed, determining that the first co-watch device or the second co-watch device are no longer displaying the video, determining that a battery powering the first co-watch device or the second co-watch device has a charge level below a threshold, and determining that the text-processing device has generated a text interpretation for a portion of the video including at least a predetermined word count: send an indication to the second device to operate as the text-processing device, and sending an indication to the first device to prepare to receive the text interpretation from the second device.

In some aspects, the techniques described herein relate to a computer-implemented method performed on a first co-watch device, the computer-implemented method including: receiving a portion of a video; processing a speech component of the portion of the video to generate a text interpretation; and sending the text interpretation to a second co-watch device for display with the portion of the video.

In some aspects, the techniques described herein relate to a computer-implemented method, wherein the first co-watch device and the second co-watch device are coordinated to concurrently display the portion of the video.

In some aspects, the techniques described herein relate to a computer-implemented method, wherein the text interpretation is at least one of a translation and a summarization of the speech component.

In some aspects, the techniques described herein relate to a computer-implemented method performed on the first co-watch device, further including: displaying the text interpretation with the portion of the video.

In some aspects, the techniques described herein relate to a computer-implemented method performed on the first co-watch device, further including: sending the text interpretation to a head mounted device operable to display the text interpretation on a head mounted device display.

In some aspects, the techniques described herein relate to a first co-watch device, including: a processor configured with instructions to: receive a portion of a video, process a speech component of the portion of the video to generate a text interpretation, and transmit the text interpretation to a second co-watch device for display with the portion of the video.

In some aspects, the techniques described herein relate to a first co-watch device, wherein the first co-watch device and the second co-watch device are coordinated to concurrently display the portion of the video.

In some aspects, the techniques described herein relate to a first co-watch device, wherein the text interpretation is at least one of a translation and a summarization of the speech component.

In some aspects, the techniques described herein relate to a first co-watch device, wherein the processor is further configured with instructions to send the text interpretation to a head mounted device operable to display the text interpretation on a head mounted device display.

In some aspects, the techniques described herein relate to a first co-watch device, wherein the processor is further configured by instructions to: display the text interpretation with the portion of the video.

### BRIEF DESCRIPTION OF THE DRAWINGS

FIG. 1 depicts an example of two users co-watching a video with text interpretation provided using a system of devices and software, according to implementations described throughout this disclosure.

FIG. 2A depicts an example head mounted device, according to implementations described throughout this disclosure.

FIG. 2B depicts an example handheld device, according to implementations described throughout this disclosure.

FIG. 3 depicts a system of devices that may be used to implement the methods described throughout this disclosure.

FIG. 4A depicts an example local space with devices that may be used by a user co-watching a video or event with other users, according to implementations described throughout this disclosure.

FIG. 4B depicts an example local space with devices that may be used by a user co-watching a video or event with other users, according to implementations described throughout this disclosure.

FIG. 4C depicts an example local space with devices that may be used by a user co-watching a video or event with other users, according to implementations described throughout this disclosure.

FIG. 5A depicts an example system of devices that may be used to implement the methods described throughout this disclosure.

FIG. 5B depicts an example system of devices that may be used to implement the methods described throughout this disclosure.

FIG. 5C depicts an example system of devices that may be used to implement the methods described throughout this disclosure.

FIG. 6A depicts an example method that may be executed by a configuration server to configure text interpretation services for two co-watching devices, according to implementations described throughout this disclosure.

FIG. 6B depicts an example method that may be executed by a configuration server to configure text interpretation services for two co-watching devices, according to implementations described throughout this disclosure.

FIG. 6C depicts an example method that may be executed by a co-watching device to provide text interpretation services, according to implementations described throughout this disclosure.

FIG. 7 depicts an example sequence diagram of signals that may be sent between devices while performing the methods described in this disclosure.

FIG. 8 depicts an example sequence diagram of signals that may be sent between devices while performing the methods described in this disclosure.

### DETAILED DESCRIPTION

Users may co-watch, or concurrently (i.e., substantially concurrently) view videos, media, or live streamed events together without sharing a device and/or without being co-located. The types of user devices that may be used to co-watch a video or event include, for example, handheld devices (smartphones and the like), head mounted devices (smart glasses, goggles, headsets and the like), neck worn lanyard devices, other mobile devices (tablet computing devices and the like), desktop and laptop computing devices, smart televisions, and/or other such devices. Server software may communicate with client software running on two or more user devices to synchronize (e.g., substantially synchronize) video streams for the remote users.

Some users may desire services that provide visual representations or interpretations of speech from a video or event to make the co-watching experience more understandable or accessible. In some examples, the text interpretation may be overlaid onto or displayed adjacent to video frames in a single display. In some examples, text interpretation services may generate an overlay that may be viewed through a head mounted or augmented reality display while viewing the video on another display device. In some examples, text interpretation services may be viewed through a head mounted virtual reality display. In some examples, one of the co-watching users may observe a live event with a camera facing outward from a head mounted display to generate a video that may be sent to other co-watching users to view on their own respective devices. Text interpretation may be provided for both the user at the live event and for the other users watching remotely from one another. In examples, watching remotely may comprise co-watching on separate respective devices, on separate local networks, or in separate locations from one another. The text interpretation services provided may comprise any combination of transcription, translation, or summary of speech.

Some users may wish to combine text interpretation services along with co-watching experiences. It may be inefficient and/or duplicative for all of the co-watching users to execute text interpretation services on their own respective devices, however. If co-watching users are using handheld devices in particular, the additional processing may reduce the battery charge level in those devices. One of the technical problems that the claims of the present Application address is how to reduce the processing load on a system of devices when providing text interpretation services during a co-watching event.

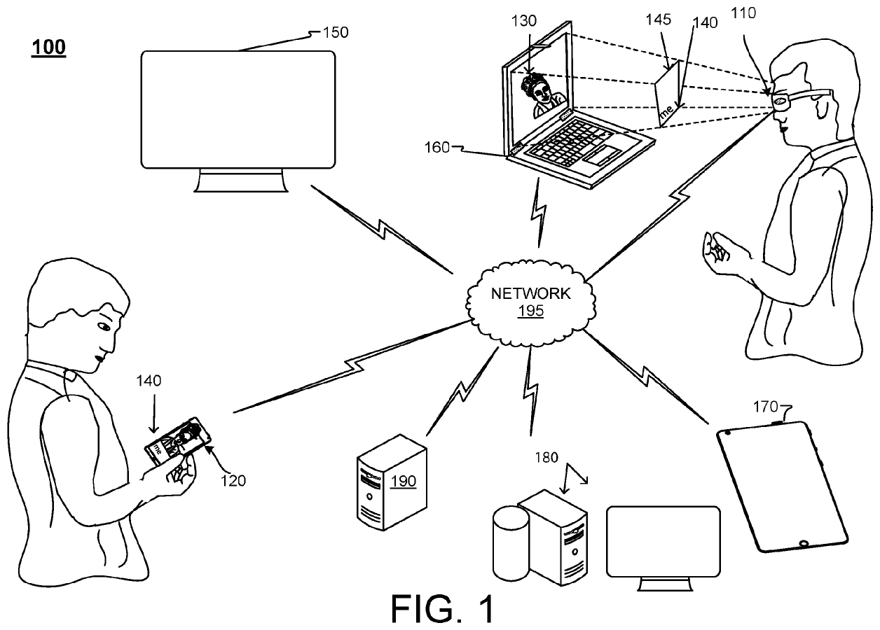

FIG. 1 illustrates two users in connection with an example system 100 which may be used to co-watch a video or event. In the example shown in FIG. 1, a first user is co-watching a video using a handheld device 120 such as, for example, a smartphone, and a second user is co-watching a video wearing a head mounted device 110, for example, an augmented reality viewing device, a virtual reality device, or smart glasses, and using a laptop device 160, for purposes of discussion and illustration. In examples, system 100 may include other computing and/or electronic devices that users may use to co-watch videos or events, however. In examples, the computing devices may communicate over a network 195 and/or over alternative network(s). Example client devices, or user devices, may also include, a display screen 150, which may comprise a television monitor or a monitor connected to any computing device, a laptop device 160, a tablet device 170, and a desktop device 180. The devices may be in communication with one or more servers 190 via the network 195. Server 190 may include, for example, a configuration server providing coordination between co-watching devices.

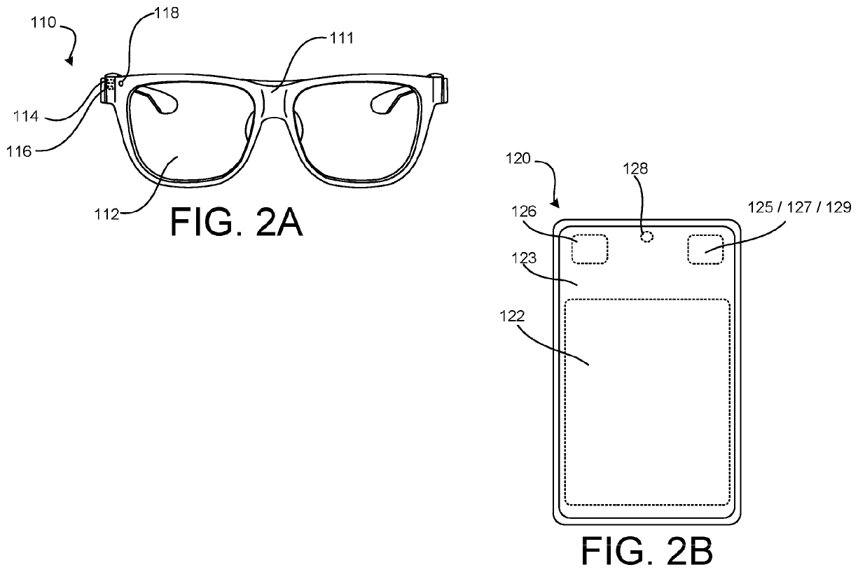

FIG. 2A depicts a front view of an example of head mounted device 110, worn by a user in FIG. 1. FIG. 2B depicts a front view of an example of handheld device 120 used by another user in FIG. 1.

The head mounted device 110, in the example shown in FIG. 2A, is an augmented reality-type display. Head mounted device 110 may include a frame 111, with a head mounted device display 112 coupled in the frame 111. In some examples, a touch surface 114 may allow for user control, input and the like of the head mounted device 110. The head mounted device 110 may include a sensing system 116 including various sensing system devices. The head mounted device 110 may include an image sensor 118 comprising any combination of a camera, a depth sensor, a light sensor, or any other such sensing devices. In some examples, the image sensor 118 may be capable of capturing still and/or moving images, patterns, features, light and the like.

Example head mounted device 110 of FIG. 2A is not intended to be limiting. In examples, head mounted device 110 may comprise a virtual reality headset (not depicted). The virtual reality headset may be connected to a respective co-watching device that communicates with a server, for example handheld device 120, or the virtual reality device may serve as its own freestanding co-watch device that communicates with network 195 and/or one or more servers 190.

Handheld device 120 includes a computing device display 122 that can display a video and/or a text interpretation of speech. In examples, handheld device 120 receives inputs from a touch surface 123 from a user. Handheld device 120 may include a sensing system 126 including various sensing system devices. Handheld device 120 may also include its own image sensor 128 comprising any combination of the features described with respect to image sensor 118 above.

Returning to the example system 100 of FIG. 1, it may be seen that a first user is watching a video 130 on computing device display 122. Video 130 is displayed with a text interpretation 140. A second user is watching video 130 on a laptop device 160 display. Text interpretation 140 for the second user is displayed on a head mounted display frame 145 instead of the laptop device 160 display. The first and second users, who may be located anywhere, are co-watching video 130 with text interpretation 140. In examples, only one of handheld device 120 or laptop device 160 may be generating text interpretation 140 and sending it to the other respective user device, as further described below.

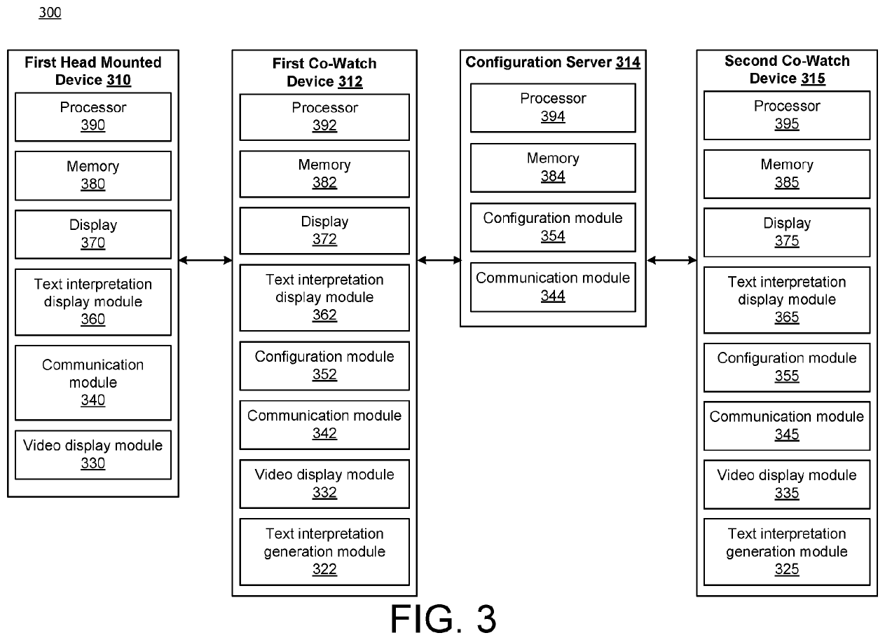

FIG. 3 depicts a block diagram of an example system 300 that may be used to implement the methods and concepts described in the present disclosure. System 300 includes first co-watch device 312, second co-watch device 315, and configuration server 314. Configuration server 314 is in communication with each of first co-watch device 312 and second co-watch device 315. In the example of system 300, first co-watch device 312 is also in communication with first head mounted device 310. This is not intended to be limiting, however, in embodiments each of first co-watch device 312 and second co-watch device 315 may be independently connected to respective head mounted devices, not connected to respective head mounted devices, or any combination therein.

First co-watch device 312 comprises a processor 392, a memory 382, a display 372, a text interpretation display module 362, a configuration module 352, a communication module 342, a video display module 332, and a text interpretation generation module 322.

Processor 392 may comprise any number of known computing device processors. Any combination of text interpretation display module 362, configuration module 352, communication module 342, video display module 332, and text interpretation generation module 322 may execute on processor 392. Processor 392 may receive inputs from input sensing components of first co-watch device 312, and process outputs.

Memory 382 comprise non-transitory memory operable to store instructions to execute text interpretation display module 362, configuration module 352, communication module 342, video display module 332, and text interpretation generation module 322.

Display 372 may comprise any display internal or external to first co-watch device 312. In examples, display 372 may comprise head mounted device display 112, computing device display 122, or display screen 150. Display 372 may display a video that a user is co-watching with at least one other user. In examples, display 372 may further display text interpretation 140.

Communication module 342 may facilitate communication between any combination of first co-watch device 312 and first head mounted device 310, configuration server 314, and one or more other, external device(s), networks, servers. In examples, communication module 342 may facilitate communication with second co-watch device 315 via a network without configuration server 314.

Text interpretation display module 362 may display text interpretation 140 on a device display. For example, text interpretation display module 362 may display text interpretation 140 on computing device display 122, head mounted device display 112, or any other display, such as display screen 150, or a display associated with laptop device 160, tablet device 170, or one or more servers 190.

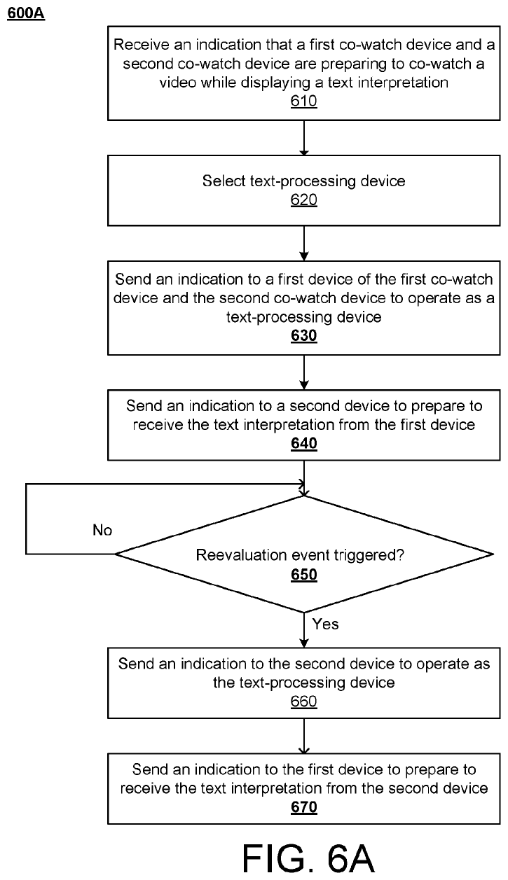

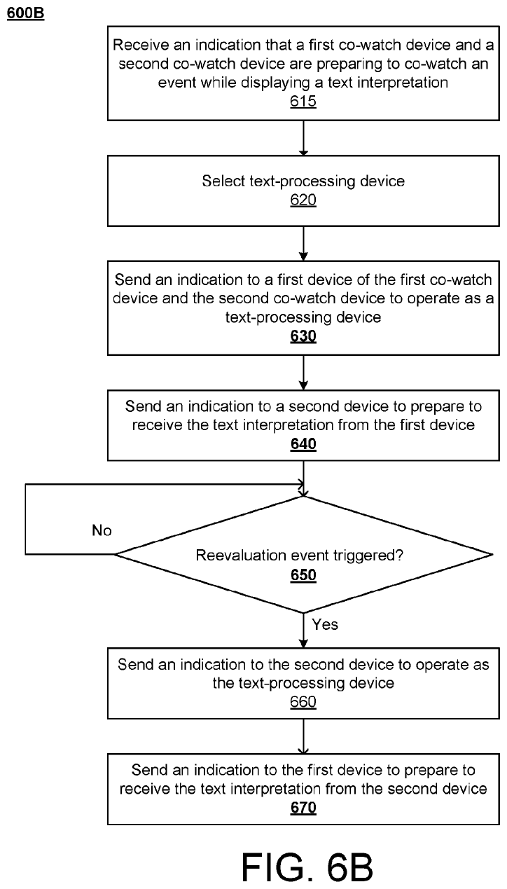

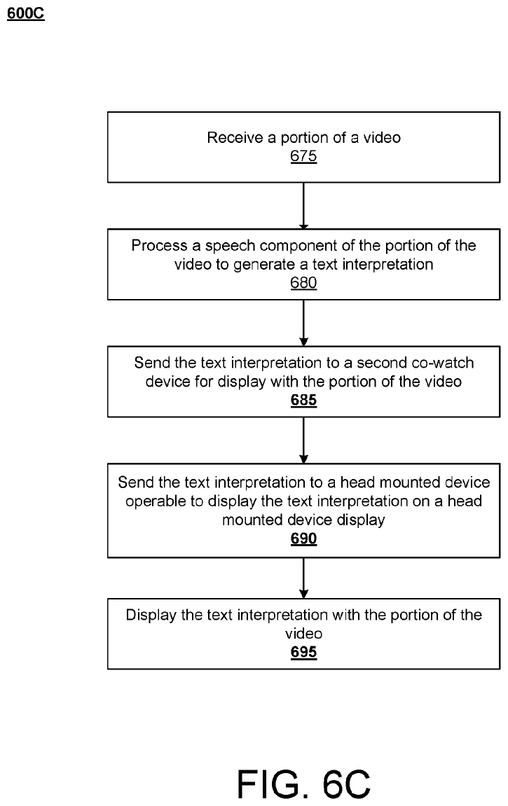

Configuration module 352 may configure each of first co-watch device 312 and second co-watch device 315 to operate as a text interpretation device generating text interpretation 140, or as a device that receives text interpretation 140 and simply displays it via text interpretation display module 362. In examples, configuration module 352 may execute the method described with respect to FIG. 6C below.

Video display module 332 may display a video on a display. In examples, video display module 332 may communicate with a server to stream video 130. In examples, video display module 332 may execute further functionality to facilitate the concurrent viewing of video 130 with other co-watch devices.

Text interpretation generation module 322 may be executed to help first co-watch device 312 perform the functions of a text interpretation device, as will be further described below.

Second co-watch device 315 may include similar components and functionality to first co-watch device 312. In examples, processor 395 may include similar functionality to processor 392, memory 385 may include similar functionality to memory 382, display 375 may include similar functionality to display 372, text interpretation display module 365 may have similar functionality to text interpretation display module 362, configuration module 355 may have similar functionality to configuration module 352, communication module 345 may have similar functionality to communication module 342, video display module 335 may have similar functionality to video display module 332, and text interpretation generation module 325 may have similar functionality to text interpretation generation module 322. In examples, system 300 may comprise further co-watch devices not depicted in FIG. 3.

Configuration server 314 comprises processor 394, memory 384, configuration module 354, and communication module 344. In examples, processor 394 and memory 384 may comprise any processor or memory operable to execute a configuration server. Communication module 344 may manage communication between first co-watch device 312, second co-watch device 315, and/or any other co-watching devices.

Configuration module 354 may be operable to coordinate the text interpretation services between co-watching devices, for example between first co-watch device 312 and second co-watch device 315. In examples, configuration module 354 may be operable to execute the methods depicted in FIGS. 6A and 6B, as further described below.

First head mounted device 310 may include processor 390, memory 380, display 370, text interpretation display module 360, and communication module 340. Processor 390 and memory 380 may comprise any processor or memory operable to operate head mounted device 310. In examples, display 370 may comprise head mounted device display 112.

In examples, text interpretation display module 360 may comprise similar functionality to that described with regards to text interpretation display module 362.

Communication module 340 may be operable to allow first head mounted device 310 to communicate with first co-watch device 312. In examples, communication module 340 may facilitate communication over Wi-Fi, Bluetooth, Zigbee, or any other known method to communicate over a local network.

In examples where first head mounted device 310 is a virtual reality device, first head mounted device 310 may further comprise a video display module 330. Video display module 330 may perform similar functionality to that described with respect to video display module 332. In the example where first head mounted device 310 is a virtual reality device, it may therefore display just the text interpretation, or both the video and the text interpretation.

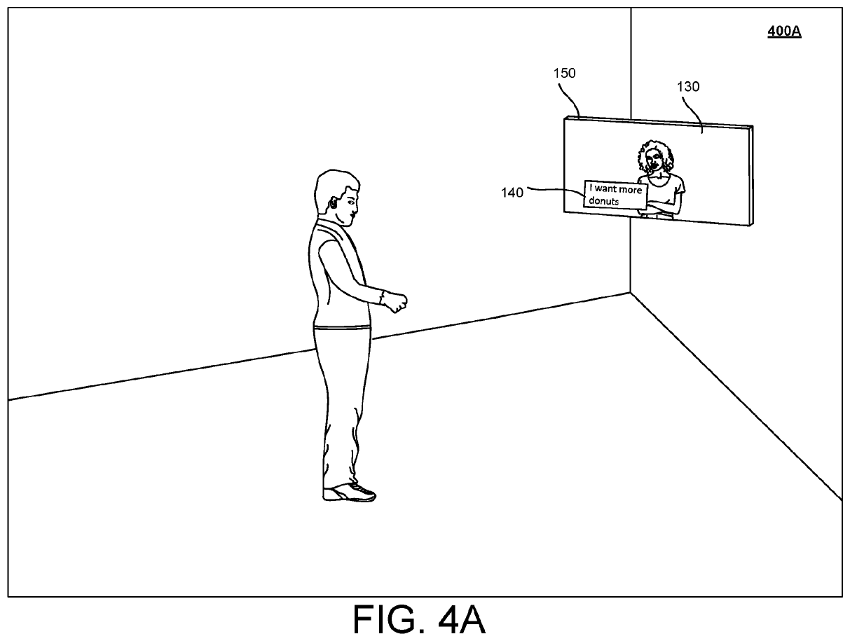

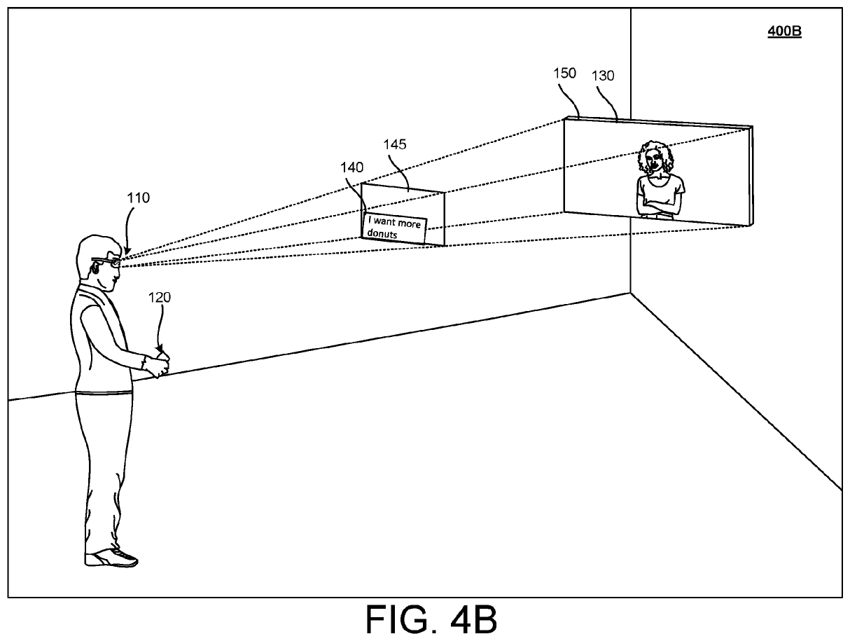

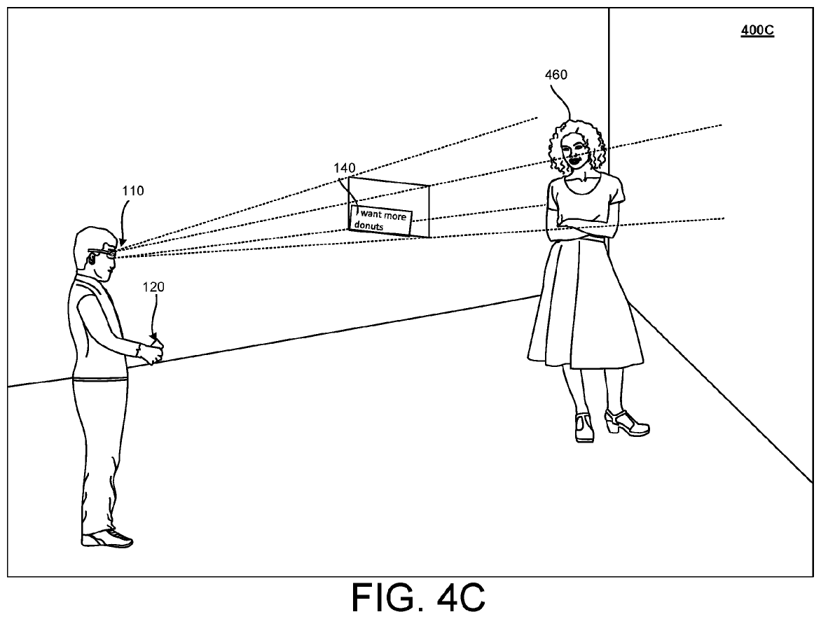

FIGS. 4A, 4B, and 4C each depict a third person perspective view of a user engaging with one or more devices in a local space. A local space is a physical space with one or more devices connected to a local Wi-Fi used alone or in conjunction by a user to co-watch content comprising a video 130 or a live event 460.

The example local space 400A and local space 400B depicted in FIGS. 4A and 4B are provided to further illustrate different ways that text interpretation 140 may be displayed for a user. Both local space 400A and local space 400B depict a user using display screen 150 to video 130 during a co-watching session. In example local space 400A, the user may view text interpretation 140 on display screen 150. In local space 400B, however, the user is using head mounted device 110 to display head mounted display frame 145 with text interpretation 140.

The example of display screen 150 in local space 400A or local space 400B is not intended to be limiting. In examples, a user may further access a video 130 using the handheld device 120, the display screen 150, laptop device 160, tablet device 170, or the desktop device 180.

In the example depicted in FIG. 4C, local space 400C comprises a user viewing a live event 460 through head mounted device 110. Local space 400C may further comprise handheld device 120, as will be further described below.

In examples, any combination of devices within local space 400A, local space 400B, or local space 400C may be connected to one or more local Wi-Fi networks. In examples, any of the devices within local spaces 400A, 400B, or 400C maybe connected to one another directly via Bluetooth. In examples, the user may log onto one or more devices in any of local spaces 400A, 400B, or 400C with the same account. Connecting and/or logging the devices of local spaces 400A, 400B and 400C onto the same accounts, may allow the devices to perform the methods of the claims.

In examples, a first user depicted in any of local spaces 400A, 400B, or 400C may co-watch a video or event with a second user using a separate respective local space 400A, 400B, 400C. In examples, first user and second user may be co-watching remotely from one another, as described above. Despite using different devices, the first and second users may view content simultaneously with one another. In examples, viewing content simultaneously may mean viewing content substantially simultaneously, or viewing content so that each user views the same frames of a video or scene from an event within a few minutes (e.g., less than 5 minutes or less than one minute) of one another. In some examples, simultaneously may mean that each user may view the same frames of a video or scene from an event within a few seconds (e.g., less than 5 seconds or less than 1 second) of one another, nearly concurrently, or concurrently.

In examples, one user may take the role of a host, sending invites to other users to join a co-watching event. One or more servers 190 accessed via a network may help facilitate initializing the respective user devices in respective local spaces 400A, 400B, 400C to view a video or an event simultaneously (i.e., substantially simultaneously). One or more servers 190 may further help coordinate co-watching a video or an event. In examples, one or more servers 190 may facilitate the streaming of frames of a video to multiple user devices simultaneously so that they can be viewed at substantially the same time by all participating users.

In example local space 400C depicted in FIG. 4C, a user is watching a live event 460 with at least one person speaking. Text interpretation 140 is displayed via head mounted display frame 145. In examples, the user may further capture video of the live event via a camera. In some examples, the camera may comprise image sensor 118 of head mounted device 110. In some examples, the camera may comprise a camera coupled to handheld device 120 or any other device operable to stream video to one or more servers 190 for distribution to the one or more other co-watching users. Other users not co-located with the user in local space 400C may therefore co-watch the live event via local space 400A or local space 400B.

In examples, text interpretation services may be configured or initialized for two or more users co-watching a video or a live event. For example, FIG. 3 depicting system 300 is described above.

System 300 includes a first co-watch device 312 and a second co-watch device 315. In examples, first co-watch device 312 and second co-watch device 315 may be located in a different local spaces 400A, 400B, or 400C, and may comprise any combination of handheld device 120, display screen 150, laptop device 160, tablet device 170, or desktop device 180. First co-watch device 312 and second co-watch device 315 are used to display video 130, which may comprise pre-recorded content or a live stream of live event 460.

System 300 further includes a configuration server 314 in communication with first co-watch device 312 and second co-watch device 315. In examples, configuration server 314 may comprise one or more servers 190. In some examples, however, configuration server 314 may execute from one of first co-watch device 312 or second co-watch device 315. In some examples, configuration server 314 may execute from the processor of one of first co-watch device 312 or second co-watch device 315.

Configuration server 314 is operable to execute the steps of method 600A depicted in FIG. 6A. In examples, method 600A includes steps 610 and 630. In some examples, method 600A may include any combination of steps 610-670, however.

Method 600A begins with step 610. In step 610, an indication is received that a first co-watch device and a second co-watch device are preparing to co-watch a video while displaying a text interpretation of a speech component of the video. Preparing to co-watch may comprise starting an application, allocating memory, setting up a communication and/or the like.

In examples, the indication may comprise a packet, command, or a request sent from any combination of a first co-watch device 312, a second co-watch device 315, or any additional devices to configuration server 314. In examples, the indication may request that configuration server 314 designate what roles each device may execute from a predetermined set of roles to provide text interpretation services to all the co-watching devices. In examples, the indication may be sent over the internet.

In examples, the speech component of the video or event may comprise an audio file or an audio component of a video including human speech. In some examples, however, the speech component may comprise a text file transliterating human speech from an audio file or an audio component of a video file. Further language processing may be performed to the speech component to generate the text interpretation. In examples, the text interpretation comprises a text sequence that may include at least one of a translation, a transcription, and a summarization of a speech component of the video or event.

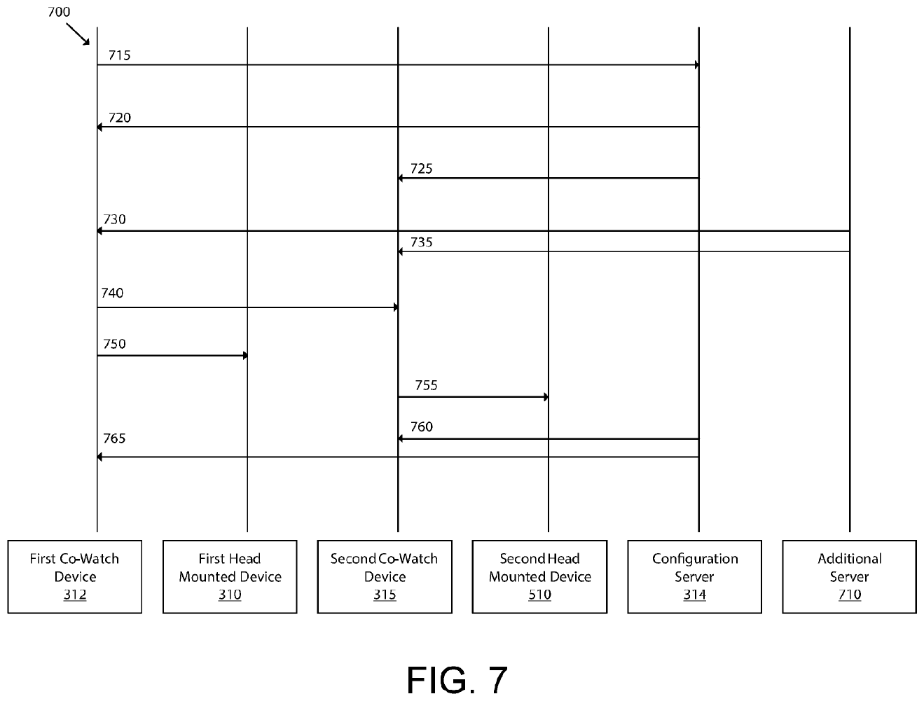

FIG. 7 depicts an example sequence diagram 700 capturing one example implementation of method 600A. Sequence diagram 700 includes a vertical line representing each of first co-watch device 312, second co-watch device 315, and configuration server 314. In examples, sequence diagram 700 may further comprise a first head mounted device 310, a second head mounted device 510, and an additional server 710. As may be seen in sequence diagram 700, from first co-watch device 312 an indication 715 may be received at configuration server 314 indicating that at least one of first co-watch device 312 and second co-watch device 315 are preparing to co-watch a video and display a text interpretation of a speech component of the video. While sequence diagram 700 depicts the indication as being sent from first co-watch device 312, this is not intended to be limiting. The indication may alternatively be sent from second co-watch device 315 or any other device being configured to co-watch a video or event with first co-watch device 312 and second co-watch device 315.

Returning to FIG. 6A, method 600A continues with step 630. In step 630, an indication is sent to a first device of the first co-watch device and the second co-watch device (e.g., one of the first co-watch device and the second co-watch device) to operate as a text-processing device to generate the text interpretation and transmit the text interpretation to a second device (e.g., the other one of the first co-watch device and the second co-watch device) of the first co-watch device and the second co-watch device while co-watching the video. The text-processing device may comprise any of first co-watch device 312, second co-watch device 315, or any additional co-watching devices operable to generate the text interpretation from the speech component of the video or live event.

Returning to example sequence diagram 700 of FIG. 7, it may be seen that indication 720 is sent from configuration server 314 to first co-watch device 312, signaling for first co-watch device 312 to operate as the text-processing device in system 500A. Upon receiving indication 720, first co-watch device 312, acting as the text-processing device, may generate the text interpretation and transmit the text interpretation to second co-watch device 315 and any other co-watching devices. While sequence diagram 700 uses the example of designating first co-watch device 312 as the text processing device, alternatively second co-watch device 315, or any other co-watch device not depicted herein, could have been designated as the text-processing device.

In examples, step 630 of method 600A may be preceded by step 620. In step 620, a text processing device may be selected by configuration server 314.

In examples, step 620 may include determining that the first device is a co-watch host device operable to initiate co-watching the video with the second device. A co-watch host device may comprise a device operable to send invites to other users via their respective co-watching devices, thereby initiating the coordination between co-watch devices. In examples, each co-watching device may execute a client application in communication with the configuration server. In examples, each co-watch client may be in communication with additional servers to help initiate and/or execute the co-watching activity.

In examples, step 620 may include determining that the first device has a first battery charge level that is greater than a second battery charge level of the second device. This may help prevent a co-watching device from excessively depleting its battery stores in order to provide text processing services.

In some examples, step 620 may comprise other criteria for determining which device is designated as the text-processing device in system 500A.

In examples, step 630 of method 600A may be executed with step 640. In step 640, an indication may be sent to the second device of first co-watch device 312 and second co-watch device 315 to prepare that device to receive the text interpretation from the first device (preparing that device to receive the text interpretation from the first device may include starting an application, allocating memory, setting up a communication and/or the like). By sending this indication, configuration server 314 may further assist to coordinate the text interpretation services between co-watching devices. For example, returning to FIG. 7, indication 725 may be sent from configuration server 314 to second co-watch device 315. In some examples, indication 725 may be sent to other co-watching devices as well.

Upon configuring a first device to operate as a text interpretation device and a second device to receive a text interpretation from the first device, first co-watch device 312 and second co-watch device 315 may commence co-watching the video or live event with text interpretation services. For example, as may be seen in sequence diagram 700, first co-watch device 312 and second co-watch device 315 may next receive streaming video packet 730 and streaming video packet 735, respectively via additional server 710. Example streaming video packet 730 and video packet 735 may comprise the same video segment received at first co-watch device 312 and second co-watch device 315 for concurrent (i.e., substantially concurrent) viewing. The example of sequence diagram 700 is not intended to be limiting, however. Any other method of concurrently streaming video may also be used.

Upon commencement of the co-watching event, text processing device, first co-watch device 312 in the example, processes a speech component of streaming video packet 730 to generate a text interpretation of the speech component. First co-watch device 312 next sends the text interpretation to second co-watch device 315 via text interpretation packet 740, allowing second co-watch device 315 to display the text interpretation along with the video for a user.

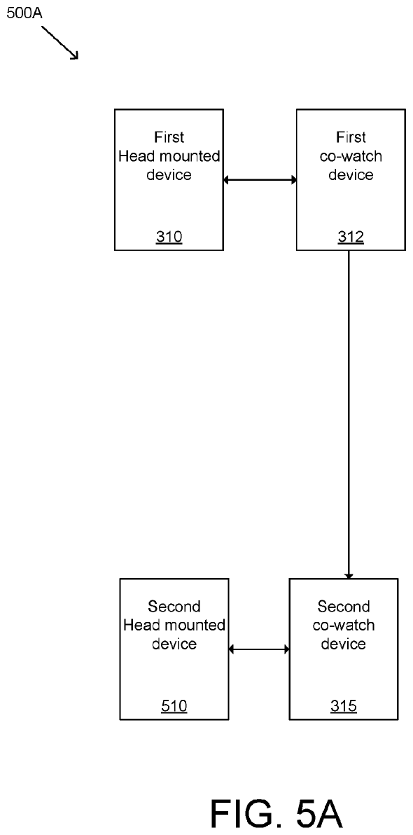

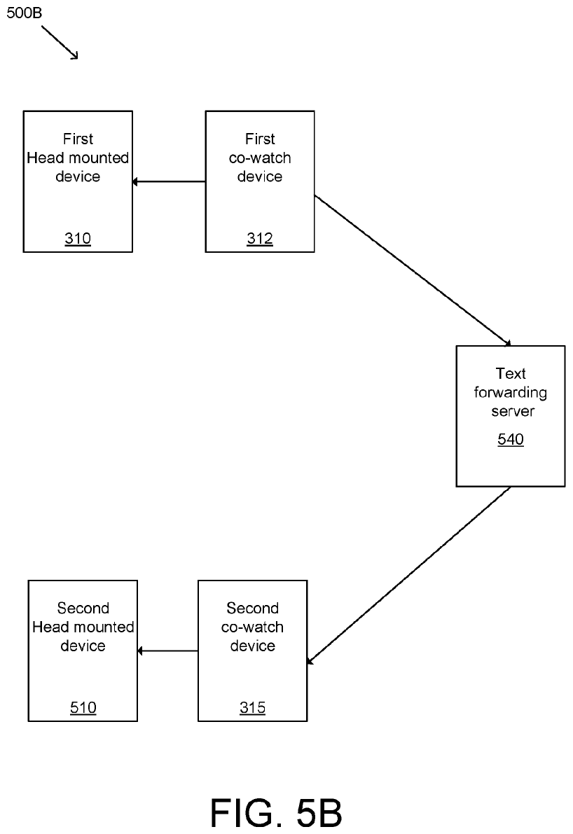

In examples, a co-watch device operating as a text interpretation device may send text interpretation packet 740 to another co-watch device using other methods. This may be seen in FIGS. 5A and 5B, depicting example system 500A and system 500B, respectively.

Example system 500A depicts first co-watch device 312 in communication with first head mounted device 310 and second co-watch device 315. Second co-watch device 315 is further in communication with second head mounted device 510. In example system 500A, first co-watch device 312 is acting as the text interpretation device. It may be seen that first co-watch device 312 is sending text interpretation packets to second co-watch device 315. In examples, the text interpretation device (first co-watch device 312) may send text interpretation packet 740 to other co-watching devices, including second co-watch device 315, directly using an IP address, a web socket, or peer-to-peer communication.

Example system 500B depicts first co-watch device 312 in communication with first head mounted device 310 and text forwarding server 540. Text forwarding server 540 is further in communication with second co-watch device 315, which is in communication with second head mounted device 510. In example system 500B, first co-watch device 312 is acting as the text interpretation device. First co-watch device 312 generates text interpretation packet 740 and sends them to text forwarding server 540. Text forwarding server 540 sends text interpretation packet 740 to second co-watch device 315. In each of system 500A and system 500B, each of first co-watch device 312 and second co-watch device 315 may forward text interpretation packet 740 to a respective head mounted device.

While the examples of system 500A and system 500B depict that first co-watch device 312 is the text interpretation device, this is not intended to be limiting. In examples, any number of co-watching devices may be used, and any co-watching device may assume the role of a text interpretation device.

In some examples, any combination of first co-watch device 312 and second co-watch device 315 may display the text interpretation via a head mounted device, such as head mounted device 110. Returning to example system 500A, it may be seen that first co-watch device 312 and second co-watch device 315 are in communication with first head mounted device 310 and second head mounted device 510, respectively.

In examples, one or more of first head mounted device 310 or second head mounted device 510, coupled to respective first co-watch device 312 and second co-watch device 315, may be used to view text interpretation 140 via head mounted display frame 145, as depicted in local space 400B. A user may therefore view a display of a video on a co-watch device such as handheld device 120, display screen 150, laptop device 160, tablet device 170, or desktop device 180 with the text interpretation displayed using the head mounted device. For example, sequence diagram 700 depicts first co-watch device 312 sending a text interpretation to first head mounted device 310 via packet 750 and second co-watch device 315 sending a text interpretation to second head mounted device 510 via packet 755, respectively.

In examples, method 600A may continue with step 650. In step 650, it may be determined whether a re-evaluation event has occurred. A re-evaluation event may comprise any predetermined event upon which configuration server 314 may re-evaluate whether to designate different roles to co-watching devices to provide text interpretation services to all the co-watch devices. The re-evaluation event may comprise at least one of: determining that a timeout period has elapsed, determining that the first co-watch device or the second co-watch device are no longer displaying the video, determining that a battery powering the first co-watch device or the second co-watch device has a charge level below a threshold, and/or determining that the text-processing device has generated a text interpretation for a portion of the video comprising at least a predetermined word count.

The list of reevaluation events provided above is not intended to be limiting. Any other reevaluation event criteria may also be used. For example, other re-evaluation events may comprise determining that a co-watch device is no longer connected.

In examples, the timeout period or the predetermined word count may be determined based on at least a first co-watch device battery charge and a second co-watch device battery charge. In examples, one of a timeout period or a predetermined word count may be selected to distribute the processing and/or battery load among the various co-watching devices.

In one example, three users may be co-watching a video or event, each respective user using a respective co-watch device. The first co-watch device battery may have 50% charge, the second co-watch device battery may have 100% charge, and the third co-watch device battery may have 25% charge. The proportion of time that each co-watch device spends operating as a text interpretation device may be proportionate to the battery charge of each co-watch device. For example, for a movie lasting X minutes, first co-watch device may operate as the text interpretation device for 2/7 of the X minutes, the second co-watch device may operate as the text interpretation device for 4/7 of the X minutes, and the third co-watch device may operate as the text interpretation device for 1/7 of the X minutes. In at least one example, the processing may be distributed among the three co-watching devices based on the number of words being processed to generate a text interpretation. For example, the first co-watch device may operate as the text interpretation device for 200 words, followed by the second co-watch device operating as the text interpretation device for the next 400 words, and the third co-watch device operating as the text interpretation device for the next 100 words. The re-evaluation event in these examples may triggered when the predetermined proportion of time or the proportion of text for each co-watch device elapses.

In examples, upon determining that step 650 has evaluated false, method 600B returns to execute step 650 again. Upon determining that step 650 has evaluated true, however, method 600B continues with step 660.

In step 660, an indication may be sent to the second device to operate as the text processing device. For example, as depicted in sequence diagram 700, configuration server 314 may send an indication 760 to second co-watch device 315 to operate as the text processing device. This step may be used to help share the processing load and battery depletion among co-watching devices, or otherwise share the burden of providing text interpretation services among devices.

In examples, method 600A may continue with step 670. In step 670, an indication may be sent to the first device of first co-watch device 312 or second co-watch device 315 to prepare that device to receive the text interpretation from the second device. For example, as may be seen and sequence diagram 700, configuration server 314 may send indication 765 to first co-watch device 312.

FIG. 6B depicts a further method 600B, in accordance with an example. Method 600B. Method 600B includes the steps of 615 and 630. In examples, however, method 600B may include any combination of steps 615-670.

Method 600B begins with step 615. In step 615, an indication is received that first co-watch device 312 and second co-watch device 315 are preparing to co-watch an event while displaying a text interpretation of a speech component of the event. Co-watch device 312 generates a video of the event with a camera and transmits the video to second co-watch device 315 for concurrent display during the event. For example, first co-watch device 312 may be present in local space 400C streaming a live event, while second co-watch device 315 is in local space 400A or local space 400B.

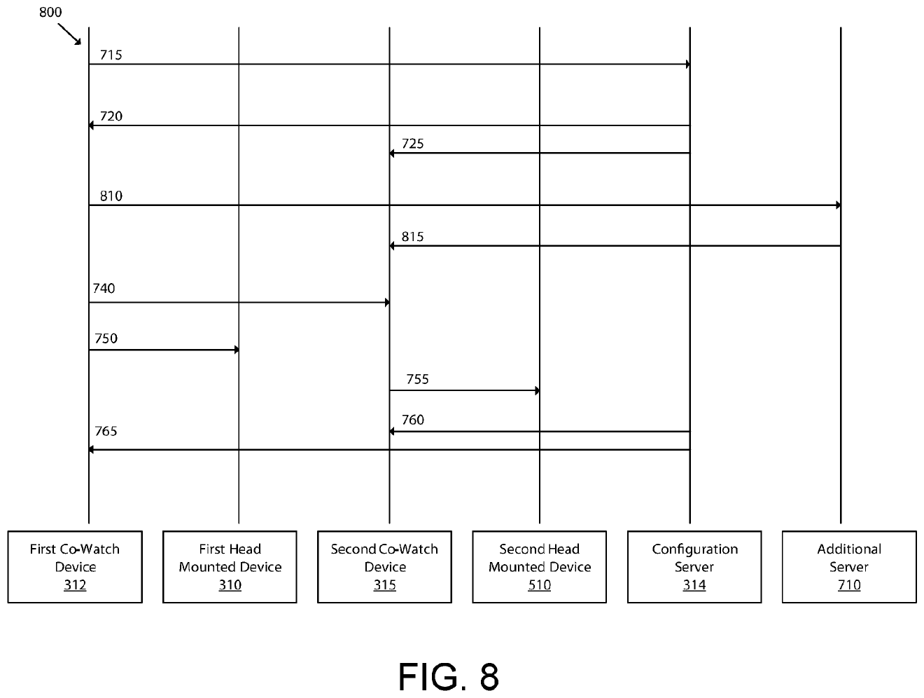

FIG. 8 depicts sequence diagram 800 in accordance with the example of method 600B. FIG. 8 includes first co-watch device 312, first head mounted device 310, second co-watch device 315, second head mounted device 510, configuration server 314, and additional server 710, similar to FIG. 7. Per step 615 of method 600B, it may be seen in sequence diagram 800 that configuration server 314 may receive an indication 715 from first co-watch device 312 signaling that first co-watch device 312 and second co-watch device 315 are preparing to co-watch a video while displaying a text interpretation of a speech component of the video. While sequence diagram 800 depicts indication 715 as being sent from first co-watch device 312, this is not intended to be limiting. In some examples, indication 715 may be sent from second co-watch device 315 or any other device being configured to co-watch a video or event with first co-watch device 312 and second co-watch device 315.

Method 600B continues with step 630. In step 630, an indication is sent to a first device of first co-watch device 312 and second co-watch device 315 to operate as a text-processing device. Step 630 is described above with regards to method 600A. For example, it may be seen in sequence diagram 800 that indication 720 is sent from configuration server 314 to first co-watch device 312.

Sequence diagram 800 representing method 600B differs from sequence diagram 700 representing method 600A in that video of a live event is generated via a camera in communication with first co-watch device 312 and sent to additional server 710 via video packet 810. Additional server 710 may then stream the video packets to second co-watch device 315 via video packet 815 for display therein.

Steps 640, 650, 660, and 670 of method 600B are similar to those described for method 600A above and comprise the same or substantially the same signals 740, 750, 755, 760, and 765 described with reference to sequence diagram 700.

FIG. 6C depicts method 600C, in accordance with an embodiment. In an example, method 600C includes steps 675, 680, and 685. In some examples, method 600C may comprise any combination of steps 675 to 695. Method 600C may be executed on a co-watch device operating as a text interpretation device, beginning with step 675.

In step 675, a portion of a video is received. For example, as may be seen in sequence diagram 700, first co-watch device 312 and second co-watch device 315 may receive streaming video packet 730 and streaming video packet 735, respectively from additional server 710.

In examples, first co-watch device 312 and second co-watch device 315 are coordinated to concurrently display the portion of the video, as described above.

Method 600C may continue with step 680. In step 680, a speech component of the portion of the video is processed to generate a text interpretation, as described above.

Method 600C may continue with step 685. In step 685, the text interpretation is sent to a second co-watch device for display with the portion of the video. For example, in sequence diagram 700, text interpretation packet 740 may be sent from first co-watch device 312 to second co-watch device 315, as described above.

In examples, method 600C may continue with step 690. In step 690 the text interpretation may be displayed with the portion of the video, according to any of the methods described above. For example, the text interpretation may be sent to first head mounted device 310 operable to display the text interpretation on a head mounted device display.

By providing a co-watch device operable to execute text interpretation for other co-watching devices, it may be possible to reduce processor cycles used by all the collective co-watching devices together. It may further be possible to decrease the battery charge used by one or more of those co-watching devices. Providing text interpretation on co-watching devices in the possession of users instead of a central server may further preserve some user privacy. Moreover, because some handheld devices and computers already include language processing software that can be used to provide text interpretation of videos or speech, it may be possible to tap those resources to provide text interpretation to all users, with lower latency for some users. By allowing one user co-watch device to provide text interpretation to other co-watching devices, it may be further possible to reduce the processor load on a text interpretation service provider.

Various examples of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above examples are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

The terminology used herein is for the purpose of describing particular examples only and is not intended to be limiting of examples. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above examples and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A computer-implemented method comprising:
receiving an indication that a first device and a second device are preparing to co-watch a video while displaying a text interpretation of a speech component of the video; and
sending an indication to a first selection of the first device and the second device to operate as a text-processing device to generate the text interpretation and transmit the text interpretation to a second selection of the first device and the second device while co-watching the video.

2. The computer-implemented method of claim 1, wherein co-watching the video comprises the first device and the second device being coordinated to concurrently display a portion of the video.

3. The computer-implemented method of claim 1, further comprising:
sending an indication to the second selection to prepare to receive the text interpretation from the first selection.

4. The computer-implemented method of claim 1, wherein the text interpretation is at least one of a translation, a transcription, and a summarization of the speech component.

5. The computer-implemented method of claim 1, wherein at least one of the first device and the second device is in communication with a head mounted device operable to display the text interpretation on a head mounted device display.

6. The computer-implemented method of claim 1, further comprising:
determining that the first selection is a co-watch host device operable to initiate co-watching the video with the second selection.

7. The computer-implemented method of claim 1, further comprising:
determining that the first selection has a first battery charge level that is greater than a second battery charge level of the second selection.

8. The computer-implemented method of claim 1, further comprising:
upon receiving an indication that a re-evaluation event has occurred, the re-evaluation event comprising at least one of: determining that a timeout period has elapsed, determining that the first device or the second device are no longer displaying the video, determining that a battery powering the first device or the second device has a charge level below a threshold, and determining that the text-processing device has generated a text interpretation for a portion of the video comprising at least a predetermined word count:
sending an indication to the second selection to operate as the text-processing device; and
sending an indication to the first selection to prepare to receive the text interpretation from the second selection.

9. The computer-implemented method of claim 8, wherein the timeout period or the predetermined word count is determined based on at least a first device battery charge and a second device battery charge.

10. A computer-implemented method comprising:
receiving an indication that a first device and a second device are preparing to co-watch an event while displaying a text interpretation of a speech component of the event, the first device generating a video of the event with a camera and transmitting the video to the second device for concurrent display during the event; and
sending an indication to a first selection of the first device and the second device to operate as a text-processing device to generate the text interpretation and transmit the text interpretation to a second selection of the first device and the second device while co-watching the event.

11. The computer-implemented method of claim 10, further comprising:
sending an indication to the second selection to prepare to receive the text interpretation from the first selection.

12. The computer-implemented method of claim 10, wherein the text interpretation is at least one of a translation, transcription, and a summarization of the speech component.

13. The computer-implemented method of claim 10, wherein at least one of the first device and the second device is connected to an augmented reality or virtual reality viewing device.

14. A system, comprising:
a first device;
a second device; and
a configuration server configured to receive an indication that the first device and the second device are preparing to co-watch a video while displaying a text interpretation of a speech component of the video, and send an indication to a first selection of the first device and the second device to operate as a text-processing device to generate the text interpretation and transmit the text interpretation to a second selection of the first device and the second device while co-watching the video.

15. The system of claim 14, wherein co-watching the video comprises the first device and the second device being coordinated to concurrently display a portion of the video.

16. The system of claim 14, wherein the configuration server is further configured to send an indication to the second selection to prepare to receive the text interpretation from the first selection.

17. The system of claim 14, wherein the text interpretation is at least one of a translation and a summarization of the speech component.

18. The system of claim 14, wherein at least one of the first device and the second device is in communication with a head mounted device operable to display the text interpretation on a head mounted device display.

19. The system of claim 14, wherein the configuration server is further configured to determine that the first selection is a co-watch host device operable to initiate co-watching the video with the second selection.

20. The system of any claim 14, wherein the configuration server is further configured to determine that the first selection has a first battery charge level that is greater than a second battery charge level of the second selection.

21. The system of claim 14, wherein the configuration server is further configured to receive an indication that a re-evaluation event has occurred, the re-evaluation event comprising at least one of: determining that a timeout period has elapsed, determining that the first device or the second device are no longer displaying the video, determining that a battery powering the first device or the second device has a charge level below a threshold, and determining that the text-processing device has generated a text interpretation for a portion of the video comprising at least a predetermined word count: send an indication to the second selection to operate as the text-processing device, and sending an indication to the first selection to prepare to receive the text interpretation from the second selection.

22. The system of claim 21, wherein the timeout period or the predetermined word count is determined based on at least a first device battery charge and a second device battery charge.

23. A computer-implemented method performed on a first device, the computer-implemented method comprising:
receiving a portion of a video;
processing a speech component of the portion of the video to generate a text interpretation; and
sending the text interpretation to a second device for display with the portion of the video.

24. The computer-implemented method of claim 23, wherein the first device and the second device are coordinated to concurrently display the portion of the video.

25. The computer-implemented method of claim 23, wherein the text interpretation is at least one of a translation and a summarization of the speech component.

26. The computer-implemented method of claim 23, further comprising:
displaying the text interpretation with the portion of the video.

27. The computer-implemented method of claim 23, further comprising:
ending the text interpretation to a head mounted device operable to display the text interpretation on a head mounted device display.

28. A first device, comprising:
a processor configured with instructions to: receive a portion of a video, process a speech component of the portion of the video to generate a text interpretation, and transmit the text interpretation to a second device for display with the portion of the video.

29. The first device of claim 28, wherein the first device and the second device are coordinated to concurrently display the portion of the video.

30. The first device of claim 28, wherein the text interpretation is at least one of a translation and a summarization of the speech component.

31. The first device of claim 28, wherein the processor is further configured with instructions to send the text interpretation to a head mounted device operable to display the text interpretation on a head mounted device display.

32. The first device of claim 28, wherein the processor is further configured by instructions to:
display the text interpretation with the portion of the video.
